(19) United States
(12) Patent Application Publication
(10) Pub. No.: US 2004/0003148 A1
(43) Pub. Date: Jan. 1, 2004

(54) Buffer management for real time systems management controller

(75) Inventors: Gunawan Ali-Santosa, Milpitas, CA (US); Rajeev Bharol, Fremont, CA (US)

Correspondence Address: David B. Ritchie, THELEN REID & PRIEST LLP, P.O. Box 640640, San Jose, CA, 95164-0640, US

(73) Assignee: Sun Microsystems, Inc., a Delaware Corporation

(21) Appl. No.: 10/295,569

(22) Filed: Nov. 14, 2002

Related U.S. Application Data
(63) Continuation-in-part of application No. 10/186,987, filed on Jun. 28, 2002.

(51) Int. Cl. G06F 3/00

(52) U.S. Cl. 710/52

(57) ABSTRACT

A buffer block allocation table as well as a buffer allocation table may be provided to handle a buffer request in a system management controller. When a buffer request is received, the buffer block allocation table may be scanned entry-by-entry to find an available buffer block. once one its located, it is marked as taken. Then, the corresponding buffer block in the buffer allocation table is scanned entry-by-entry looking for one that is available. If one is found, it is used for the buffer request. If one cannot be found, the system may return to the buffer block allocation table and continue with the next entry. This process may repeat until an available buffer is found.

### CROSS-REFERENCE TO RELATED APPLICATION

The present application is a continuation-in-part of co-pending application Ser. No. 10/186,987, filed on Jun. 28, 2002, by Gunawan Ali-Santosa and Rahmat Mortazavi, entitled “PROCESS MANAGEMENT FOR REAL TIME SYSTEMS MANAGEMENT CONTROLLER”, attorney docket no. SUN-P5671.

### FIELD OF THE INVENTION

The present invention relates to the field of computer science. More particularly, the present invention relates to real time buffer management of system controllers and satellite boards.

### BACKGROUND OF THE INVENTION

With the arrival of the Internet as a mainstream tool for commerce, the need for high levels of reliability and uptime in network communications has grown exponentially. Whereas at one time, Internet users accepted that communications between computers were unreliable, now they expect the same level of uptime and reliability that they receive in their basic telephone service. This need for so-called “high availability” network services has forced networking companies and Internet providers to focus on reliability when purchasing equipment, for the simple reason that those that do not will lose customers. The telecommunications sector, therefore, has a great need for “high availability” systems.

One solution is to create chasses with multiple boards a piece. These boards may then include some redundancies, so if one of the boards fails, another can take over with little or no loss of function. FIG. 1 is a block diagram illustrating an example of a chassis. Slots 1 and 2 (100, 102) are typically called the system slots. Slot 1 generally contains the board that functions as the Systems Controller (SBC). Slot 2 may then optionally be populated with a standby system card for redundancy. This is typically called a Standby SBC (SSBC). Slot 3 and beyond are called Satellite slots (SATs). These typically will contain peripheral boards used for varied applications, however it is possible that the boards may also be identical to those in Slot 1 and Slot 2.

Each board may contain several components. FIG. 2 is a block diagram illustrating a typical board for mounting in a chassis. A system management controller (SMC) 200 is responsible for communicating with its own Central Processing Unit (CPU) 202 and other devices on its own board (such as temperature sensors 204) as well as communication with other boards. The SMC on the SBC (in the system slot) is called the Baseboard Management Controller (BMC), which in addition to controlling and communicating with its own CPU, is also capable of controlling the communications between boards, as well as accepting events from other cards (mainly the SATs). Events are occurrences that require some sort of attention by the system, and are typically handled by creating tasks for the events and the handling the tasks in an appropriate order.

Communication between boards, however, requires that the system must be designed to deal with the inevitable increase in traffic between boards. Additionally, unless it is run properly, the BMC may miss an important event, and may cause system failure.

Events may come synchronously, asynchronously or unexpectedly. An example of the latter may be the temperature exceeding a maximum threshold that requires an urgent need for attention. All these events must be handled in an intelligent fashion or critical errors may occur. For example, the temperature exceeding a maximum threshold could result in the system overheating unless it is dealt with quickly. Likewise, events that come synchronously should be handled with a minimum of user intervention.

What is needed is a mechanism to manage task resources in an efficient manner.

### BRIEF DESCRIPTION OF THE INVENTION

Multiple devices can request resources simultaneously in a computer system. In order to prevent buffer corruption, a buffer block allocation table as well as a buffer allocation table may be provided to handle a buffer request in a system management controller. When a buffer request is received, the buffer block allocation table may be scanned entry-by-entry to find an available buffer block. Once one is located, it is marked as taken. Then, the corresponding buffer block in the buffer allocation table is scanned entry-by-entry looking for one that is available. If one is found, it is used for the buffer request. If one cannot be found, the system may return to the buffer block allocation table and continue with the next entry. This process may repeat until an available buffer is found.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram illustrating an example of a chassis.

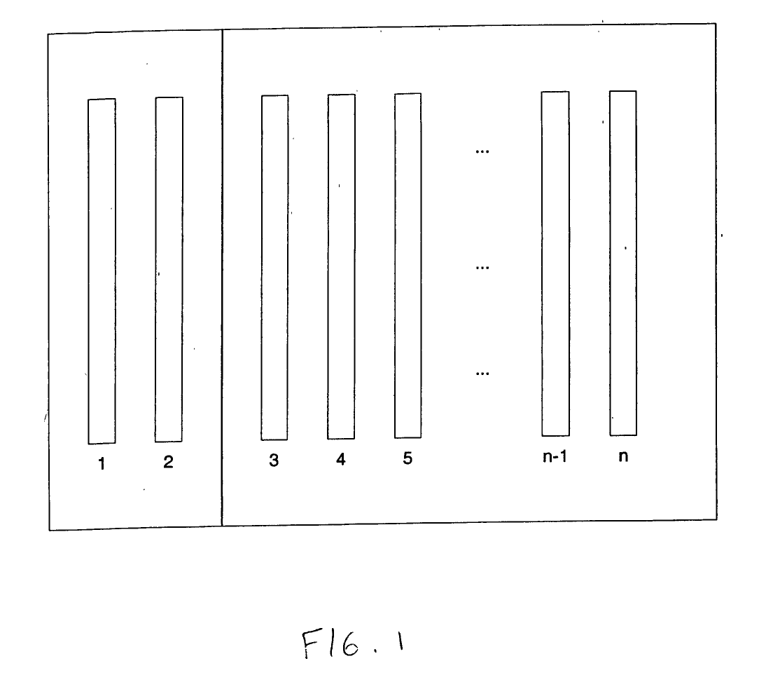

FIG. 2 is a block diagram illustrating a typical board for mounting in a chassis.

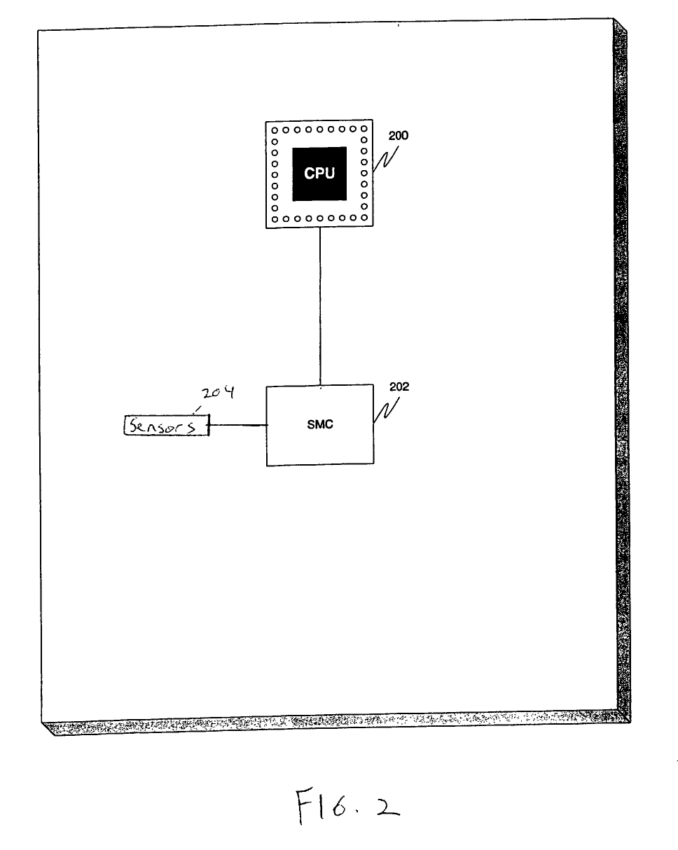

FIG. 3 is a block diagram illustrating a BMC in accordance with a specific embodiment of the present invention.

FIG. 4 is a diagram illustrating a process control block in accordance with a specific embodiment of the present invention.

FIG. 5 is a flow diagram illustrating a method for managing a task in a system management controller, wherein the task has a corresponding process control buffer, in accordance with a specific embodiment of the present invention.

FIG. 6 is a block diagram illustrating the handling of interrupts in accordance with a specific embodiment of the present invention.

FIG. 7 is a block diagram illustrating an apparatus for managing a task in a system management controller, wherein the task has a corresponding process control buffer, in accordance with a specific embodiment of the present invention.

FIG. 8 is a diagram illustrating a typical buffer allocation table.

FIG. 9 is a diagram illustrating a buffer block allocation table and a buffer allocation table in accordance with a specific embodiment of the present invention.

FIG. 10 is a flow diagram illustrating a method for handling a buffer request in accordance with a specific embodiment of the present invention.

FIG. 11 is a block diagram illustrating an apparatus for handling a buffer request in accordance with a specific embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention handles task management by utilizing a specialized buffer known as a process control block (PCB). This process control block may then be used with specialized processes in order to handle the tasks as they arrive. Tasks may be divided into three types. A task that is executed immediately, and executed once, is known as a simple task. Another type of task is one that is executed at a predetermined time. The third type of task is one that is executed more than once. Tasks may also be combinations of any of these three task types. For example, a task may be executed more than once, beginning at a predetermined time. A separate PCB may be maintained for each task.

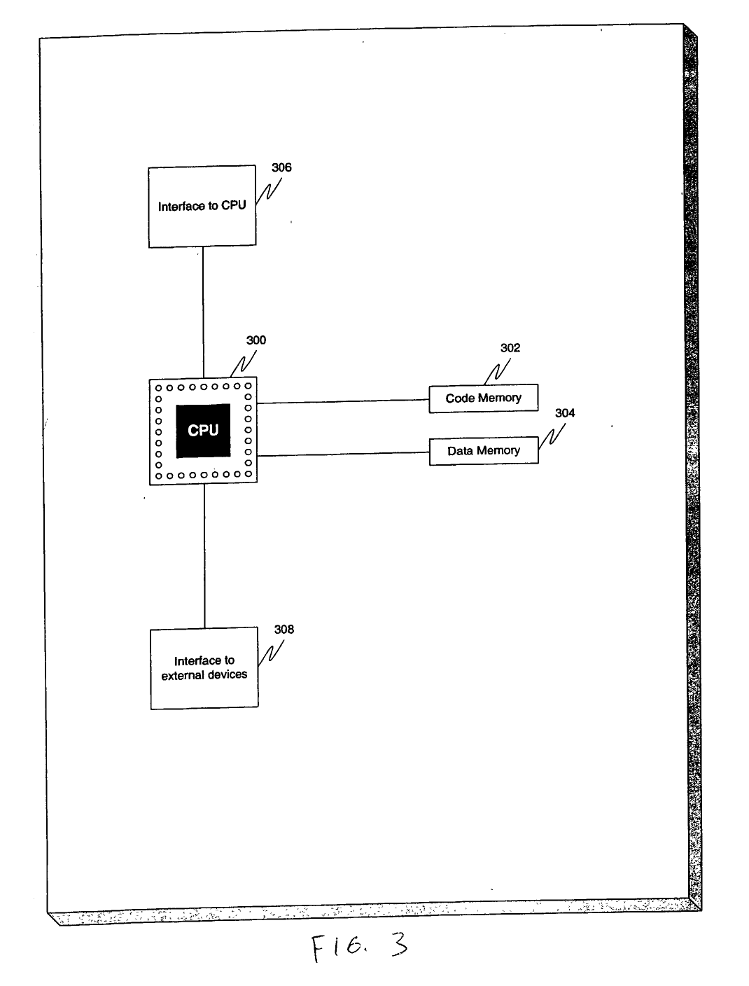

FIG. 3 is a block diagram illustrating a BMC in accordance with a specific embodiment of the present invention. A CPU 300 may be coupled to code memory 302 which controls the BMC operation. Data memory 304 may be used to store data and the state machine of the BMC. An interface to the CPU 306 may be used to communicate with the CPU, while an interface to external devices 308 can be used to communicate with external devices such as temperature sensors, and communications channels like an I2C bus between boards or an RS232 to communicate with the terminal on the SMC side for monitoring purposes.

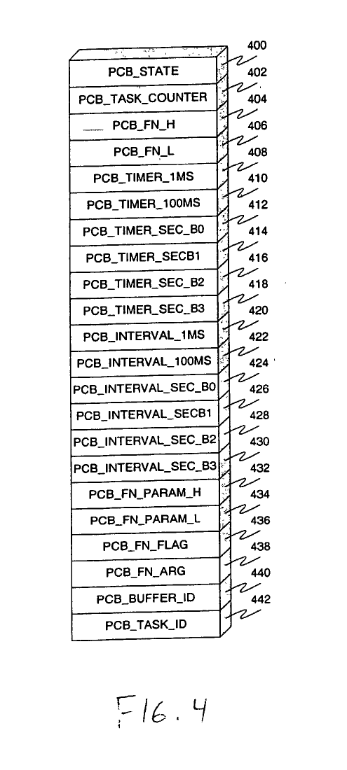

The PCB may contain a number of registers that provide task management capabilities. FIG. 4 is a diagram illustrating a process control block in accordance with a specific embodiment of the present invention. STATE 400 indicates if the PCB is active or inactive. If it is active, then the task needs to be executed. If it is inactive, it need not be executed and the Executive Loop may skip it and quickly check the next PCB.

PCB_TASK_COUNTER 402 then indicates whether the task needs to be run immediately, and if not, how many times it needs to be run. A “0” in this field indicates that the task should be run immediately. A “1” or more in this field indicates that the task should be run that many times, and also that it should not be run immediately. Thus, a “1” would indicate that the task should be run once at some point in the future, whereas a “2” would indicate that the task should be run twice beginning at some point in the future separated by the timing interval. The highest value (e.g., “0xFF”) in PCB_TASK_COUNTER field may indicate that the task should be run repetitively forever. The use of the task counter allows the Executive Loop to avoid calculating the timing if the task is a simple one, i.e., if it should be run immediately.

A PCB_FN_H 404 and PCB_FN_L 406 field contain a function pointer, which points to the function of the task associated with the PCB. If there are parameters or other data to pass, they are contained in the PCB_FN_PARAM_H 432, PCB_FN_PARAM_L 434, PCB_FN_FLAG 436, and PCB_FN_ARG 438 fields. PCB_FN-H 404 and PCB_FN_L 406 may be located immediately after PCB_TASK_COUNTER 402 so that if the task is a simple one, the function may be immediately executed.

Timer fields 408, 410, 412, 414, 416, 418 then indicates the time that the task should be run, if at a predetermined time. The value in the fields represents the time the task should execute in relation to the time of power-up. So a value of 10 ms in the fields indicates that the task should run 10 ms after power-up. At power-up, these fields are set to 0. Therefore, for non-simple tasks, the timing information in the PCB must be synchronized with the current time stamp stored in those registers. The fields may encompass a 1 ms field, a 100ms field, and 4 second fields, each field holding a value from 0 to 99. There are many alternative ways to format the timer fields.

Interval fields 420, 422, 424, 426, 428, 430 are used to determine the period between executions for tasks that are executed more than once.

Additionally, PCB_BUFFER_ID 440 and PCB_TASK_ID 442 are provided. PCB_BUFFER_ID 440 can be used to free the buffer once the task is completed or terminated. PCB_TASK_ID 442 is used to search for any tasks that are to be removed or aborted.

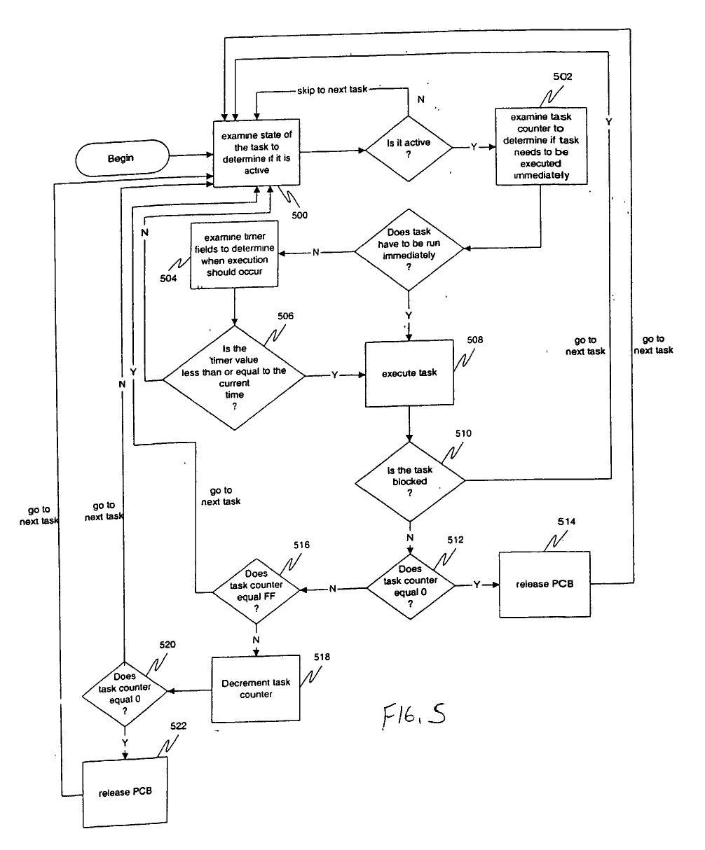

FIG. 5 is a flow diagram illustrating a method for managing a task in a system management controller, wherein the task has a corresponding process control buffer, in accordance with a specific embodiment of the present invention. At 500 a state of the task is examined to determine if it is active, the state contained in the process control buffer. If it is inactive, the task manager skips this task. If it is active, then at 502 a task counter contained in the process control buffer is examined to determine if the task needs to be run now or later. If it is later, then the method needs to determine when precisely it must begin execution. Thus, at 504, timer fields may be examined which indicate at what time the first execution should occur. These timer fields may measure time in millisecond intervals and may indicate the execution time. In that regard, the timer fields may compared with a time clock maintained by the system to determine if it is time to make the execution. In a specific embodiment of the present invention, the timer fields are made up of six timer fields of one byte each. The least significant byte indicates the number of milliseconds, the second least significant byte indicates the number of hundreds of milliseconds, and the rest of the bytes represent a 32-bit integer value of the amount of time in seconds. Additionally, one of ordinary skill in the art will recognize that the timer fields may actually comprise a single field depending upon implementation. Thus, the word “timer fields” should be interpreted to include a single field.

At 506, it is determined if the timer fields are less than or equal to the current time. If not, then it is not time to execute the task and the process may return to 500, where the process begins anew with another PCB. At 508, once the execution time has been met or passed, or if the task has to be run immediately, the task is executed. This may involve examining function pointers to determine which function(s) to execute and then executing those functions using any parameters specified by parameter pointers. The parameters may indicate where buffers utilized by the functions are located. A flag parameter may then be used to indicate whether the buffer should be released upon completion. This is important in buffer management, as it can save some execution time. A buffer ID may be used to identify the buffer to be released.

At 510, it is determined if the task is blocked. A task may be blocked when its resources are being used. A global flag may be set for the resources when in use, and any additional uses of the resources may be precluded until the resources are released and the flag reset to zero.

At 512, it is determined if the task counter equals zero. If so, then the method has successfully executed the task the number of times requested by the user, and thus the PCB may be released at 514, at which point the process may repeat with a different PCB. If it is nonzero, then at 516 it is determined if the task counter is at a maximum (0xFF in a specific embodiment of the present invention). 0xFF may indicate that the task should be run repetitively forever. One of ordinary skill in the art will recognize that an indicator that the task should be run repetitively forever may take many forms, and that utilizing a maximum number is only one possible embodiment.

If the task counter equals 0xFF, then the process may simply begin again. If not, then the task counter must be decremented at 518. Then, at 520, the task counter is once again checked to see if it is zero. If so, then at 522, the PCB is released and the process then moves on to the next task at 500. Otherwise, the process returns to 500 without releasing the PCB.

In another embodiment of the present invention, a PCB bypass may be used. Occasionally, there are tasks that must be executed immediately or urgently. For example, watchdog or heartbeat tasks are these types of tasks. For normal interrupts, the interrupt signal may simply be passed to the task management executive loop, which can then deal with the interrupt the next time it has control (if the tasks are in execution, the executive loop has passed control to the code/function to be executed). For special interrupts like the watchdog task, when the CPU responds to the SMC/BMC watchdog warning, it responds through the interrupt routine of the SMC communication channel. The SMC interrupt routine can then recognize this event, and immediately execute code that intercepts and neutralizes the watchdog timer. This prevents the SMC from accidentally resetting the CPU, thinking that it is about to hang. Additionally, the SMC can also initiate a task that will use the PCB Bypass method, and generate an outgoing request/packet to another board. This is useful at the early stages of power up when the PCB and task management have not been initialized yet, and the SMC cannot wait until they are ready.

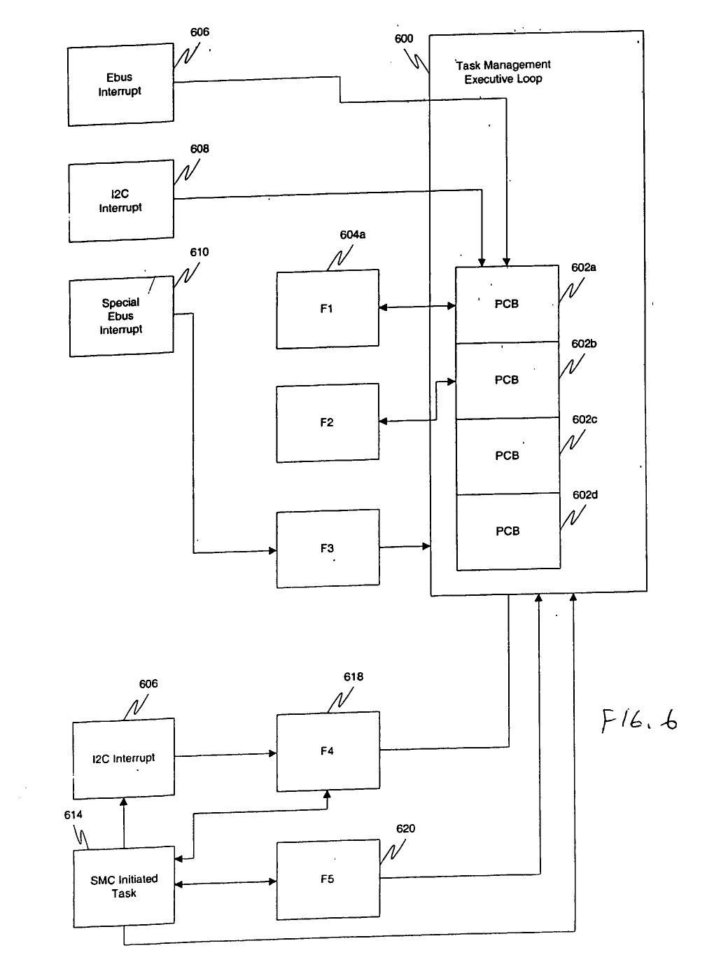

FIG. 6 is a block diagram illustrating the handling of interrupts in accordance with a specific embodiment of the present invention. The task management executive loop 600 executes one or more PCBs 602a-602d. Upon execution of a PCB 602a, control is passed to a corresponding function 604a where the function is executed. Once complete, control is returned to the task management executive loop 600. If an ebus interrupt 606 or an I²C interrupt 608 is initiated, the task management loop 600 loses control and the ebus interrupt 606 or I²C interrupt 608 takes over, builds the PCB, and passes control back to the task management loop 600 with the PCB. If, on the other hand, a special Ebus interrupt 610 is initiated, the interrupt may be passed directly to the code/function to be executed 612, bypassing both the PCB and the executive loop, after which control may be passed back to the task management executive loop.

If the task management executive loop 600 has not started up yet, then an SMC initiated task 614 may generate an I²C interrupt 616 which may then execute a function 618, bypassing the executive loop. Control then may be passed to the task management executive loop 600 or back to the SMC initiated task 614 if the task management executive loop is not ready. The SMC initiated task 614 may also directly execute a function 620.

Additionally, a task interlock may be utilized to interlock two tasks if, for example, one task cannot run until the other has been completed. A 2 level timer for heartbeat monitoring of the CPU is such an example. Another example is a second timer countdown if a warning to the CPU has not been transmitted.

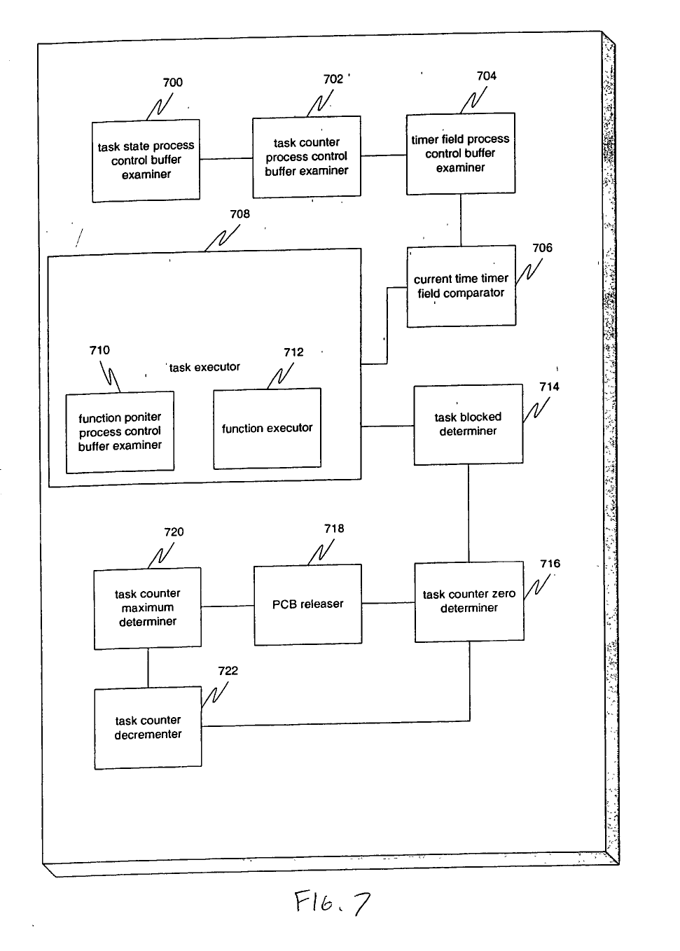

FIG. 7 is a block diagram illustrating an apparatus for managing a task in a system management controller, wherein the task has a corresponding process control buffer, in accordance with a specific embodiment of the present invention. A task state process control buffer examiner 700 examines a state of the task to determine if it is active, the state contained in the process control buffer. If it is inactive, the task manager skips this task. If it is active, then a task counter process control buffer examiner 702 coupled to the task state process control buffer examiner 700 examines a task counter contained in the process control buffer to determine if the task needs to be run now or later. If it is later, then the method needs to determine when precisely it must begin execution. Thus, a timer field process control buffer examiner 704 coupled to the task counter process control buffer examiner 702 may examine timer fields which indicate at what time the first execution should occur. These timer fields may measure time in millisecond intervals and may indicate the execution time. In that regard, the timer fields may compared with a time clock maintained by the system to determine if it is time to make the execution. In a specific embodiment of the present invention, the timer fields are made up of six timer fields of one byte each. The least significant byte indicates the number of milliseconds, the second least significant byte indicates the number of hundreds of milliseconds, and the rest of the bytes represent a 32-bit integer value of the amount of time in seconds. Additionally, one of ordinary skill in the art will recognize that the timer fields may actually comprise a single field depending upon implementation. Thus, the word “timer fields” should be interpreted to include a single field.

A current time timer field comparator 706 coupled to the timer field process control buffer examiner 704 determines if the timer fields are less than or equal to the current time. If not, then it is not time to execute the task and the process begins anew with another PCB. A task executor 708 coupled to said current timer field comparator 706 executes the task once the execution time has been met or passed, or if the task has to be run immediately. This may involve examining function pointers with a function pointer process control buffer examiner 710 to determine which function(s) to execute and then executing those functions using any parameters specified by parameter pointers using a function executor 712. The parameters may indicate where buffers utilized by the functions are located. A flag parameter may then be used to indicate whether the buffer should be released upon completion. This is important in buffer management, as it can save some execution time. A buffer ID may be used to identify the buffer to be released.

A task blocked determiner 714 coupled to said task executor 708 determines if the task is blocked. A task may be blocked when its resources are being used. A global flag may be set for the resources when in use, and any additional uses of the resources may be precluded until the resources are released and the flag reset to zero.

When a task is blocked, the PCB data is left intact. The executive loop will retry on the next turn.

A task counter zero determiner 716 coupled to said task blocked determiner 714 determines if the task counter equals zero. If so, then the method has successfully executed the task the number of times requested by the user, and thus the PCB may be released using a PCB releaser 718 coupled to said timer field zero determiner 716, at which point the process may repeat with a different PCB. If it is nonzero, then a task counter maximum determiner 720 coupled to said task counter zero determiner 716 determines if the task counter is at a maximum (0xFF in a specific embodiment of the present invention). 0xFF may indicate that the task should be run repetitively forever. One of ordinary skill in the art will recognize that an indicator that the task should be run repetitively forever may take many forms, and that utilizing a maximum number is only one possible embodiment.

If the task counter equals 0xFF, then the process may simply begin again with another PCB. If not, then the task counter must be decremented using a task counter decrementer 722 coupled to said task counter maximum determiner 720 and to the task counter zero determiner 716. Then the task counter is once again checked using the task counter zero determiner 716 to see if it is zero. If so, then the PCB is released by the PCB releaser 718 and the process then moves on to the next task. Otherwise, the process repeats without releasing the PCB.

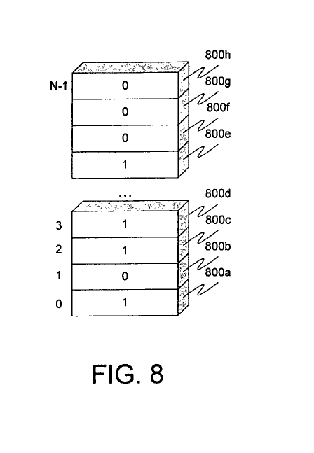

The information regarding which memory space is used and which task owns it may be stored in a fixed location known as a Buffer Allocation Table (BAT). FIG. 8 is a diagram illustrating a typical BAT. Each entry 800a-800h may comprise a single byte or more of data. In a simple version, it may contain just one byte representing a flag, the flag indicating whether the corresponding memory location is used (flag=1) or unused (flag=0).

However, the nature of the controller is that a packet may come in at anytime, and it may come from multiple sources simultaneously. For example, 2 boards may at the same time send warnings about temperature over the threshold to the BMC. Alternatively, another board may send a packet to the BMC and at the same time the CPU may send a command via an interface. In such circumstances, the BAT entry may be corrupted. For example, an Intelligent Platform Management Interface (IPMI) packet may be sent by a board to the BMC. The code may then read the BAT entries to find a buffer that is available. It finds that BAT entry 800b is 0, therefore it is free. It may be about to mark it as taken when it is interrupted by a command coming in from the Keyboard Controller Style (KCS) interface, which will require a buffer as well. It therefore cuts in front of the IPMI packet and takes BAT entry 800b for itself, seeing it not marked as taken. When the code returns from the interrupt routine, it then will also claim BAT entry 800b for the IPMI task. Not only has the packet buffer been corrupted, but the PCB buffer is equally corrupted.

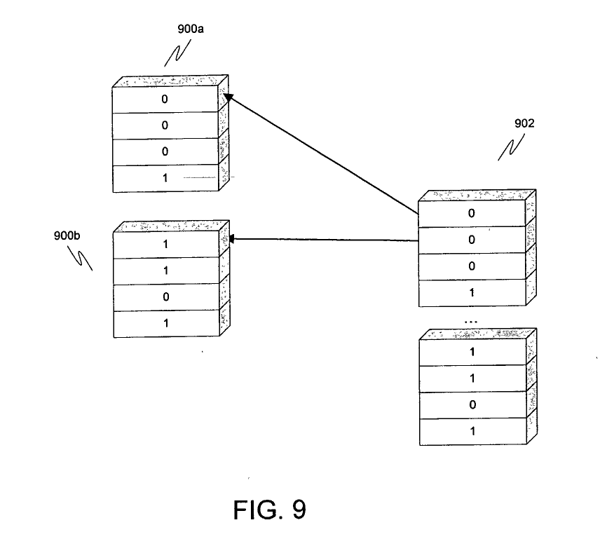

Therefore, what is needed is a buffer management solution which solves this problem and also runs in a reasonable amount of time. If it takes too long, the system will not work properly as it may miss a packet. In a specific embodiment of the present invention, a buffer block allocation table (BBAT) is utilized in addition to the BAT. This essentially creates a two dimensional buffer allocation table. FIG. 9 is a diagram illustrating a BBAT and BAT in accordance with a specific embodiment of the present invention. The BAT 800 may be divided into several blocks 900a, 900b. For illustrative purposes, four entries per block are utilized but one of ordinary skill in the art will recognize that any number of entries per block may be used. Each entry within a block may be indexed from 0 to 3. The BBAT 902 may then contain entries corresponding to blocks in the BAT 800. These may be called block index allocation entries.

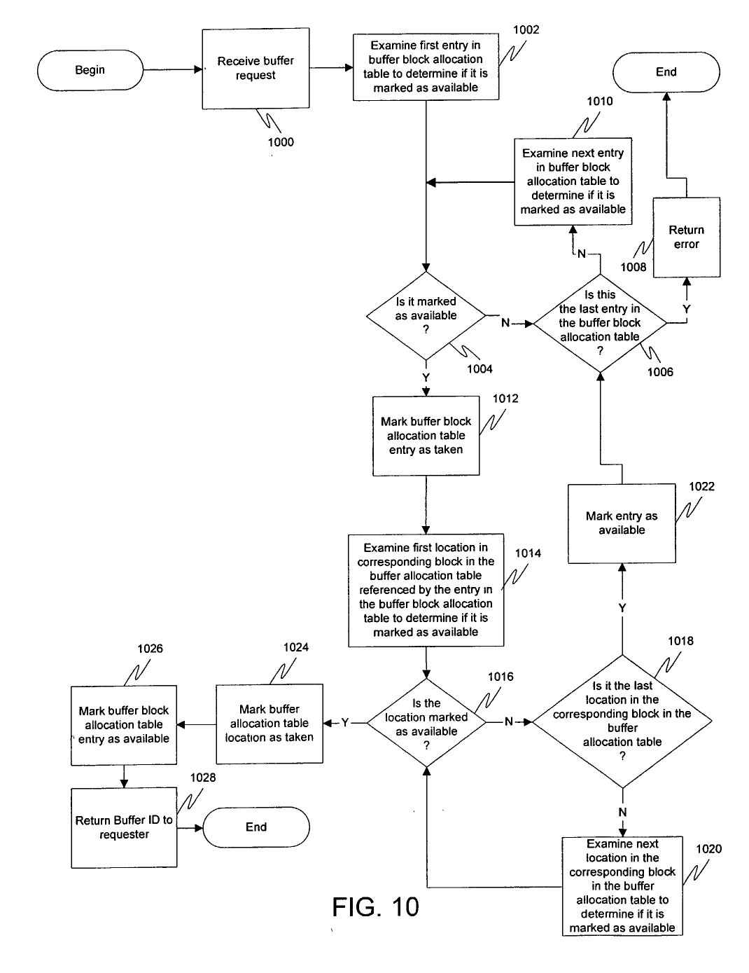

FIG. 10 is a flow diagram illustrating a method for handling a buffer request in accordance with a specific embodiment of the present invention. At 1000, a buffer request is received. A buffer block allocation table is scanned entry-by-entry to find an available buffer block. Therefore, at 1002 the first entry in the buffer block allocation table is examined to determine if it is marked as available. At 1004, if it is not marked as available, then at 1006 it is determined if this entry is the last one in the buffer block allocation table. If so, then at 1008 an error should be returned as there are no available blocks and the requester needs to be notified. If it is not the last entry in the buffer block allocation table, then at 1010 the next entry in the buffer block allocation table is examined to determine if it is marked as available.

At 1012, the available buffer block is marked as taken in the buffer block allocation table. At 1014, the first location in the buffer allocation table is examined to determine if it is marked as available. At 1016, if the location is not marked as available, then at 1018 it is determined if this is the last location in the corresponding block in the buffer allocation table. If not, then at 1020 the next location in the corresponding block in the buffer allocation table may be examined to determine if it is marked as available. Then 1016 is repeated. If at 1018 it is determined that it is the last location in the corresponding block in the buffer allocation table, then at 1022 the entry is marked as available and the process moves on to see if all the blocks have been examined at 1006.

If at 1016 it was determined that the location is marked as available, then at 1024 the location is marked as taken. Then at 1026, the buffer block allocation table entry may be marked as available. Then at 1028, the buffer ID is returned to the requester, who then may utilize it and release the location.

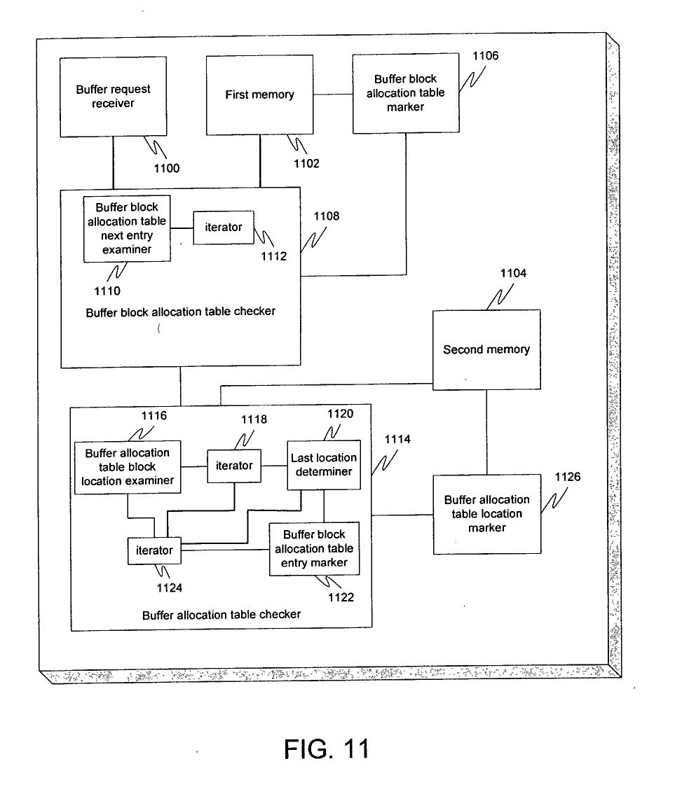

FIG. 11 is a block diagram illustrating an apparatus for handling a buffer request in accordance with a specific embodiment of the present invention. A buffer request receiver 1100 may receive a buffer request. A first memory 1102 may store a buffer block allocation table while a second memory 1104 may store a buffer allocation table. One of ordinary skill in the art will recognize that the memories may be combined. A buffer block allocation table checker 1106 coupled to the buffer request receiver 1100 and the first memory 1102 may check the buffer block allocation table for an entry indicating an available block. The buffer block allocation table checker 1106 may include a buffer block allocation table next entry examiner 1108, which examines the next entry in the buffer block allocation table to determine if it is marked as available. It may also include a iterator 1110 coupled to the buffer block allocation table next entry examiner 1108 which repeats the examining if it is not marked as available. This may continue until the last entry in the buffer block allocation table is reached, at which point an error may be returned to the requester.

A buffer block allocation table marker 1112 coupled to the first memory 1102 and to the buffer block allocation table checker 1106 may mark the available buffer block as taken in the buffer block allocation table. A buffer allocation table checker 1114 coupled to the second memory 1104 and to the buffer block allocation table checker 1106 may check a buffer allocation table block corresponding to the buffer block allocation table entry for an entry indicating an available block. This may include a buffer allocation table block location examiner 1116, which may examine the first location in the buffer allocation table to determine if it is marked as available. A last location determiner 1118 coupled to the buffer allocation table block location examiner 1116 may determine if this is the last location in the corresponding block in the buffer allocation table. If not, then a iterator 1120 coupled to the buffer allocation table block first location examiner 1116 and to the last location determiner 1118 may repeat the examining and determining if the location is not the last location in the buffer allocation table block using the next entry in the block. If it is determined that it is the last location in the corresponding block in the buffer allocation table, then the buffer block allocation table entry is marked as available by a buffer block allocation table entry marker 1122 coupled to the last location determiner 1118. A second iterator 1124 coupled to the buffer allocation table block location examiner 1116, the last location determiner 1118, the iterator 1120, and the buffer block allocation table entry marker 1122 may repeat the checking a buffer block allocation table, marking the buffer block allocation table entry, checking the buffer allocation table block, and marking the buffer allocation table block entry with a next entry in the buffer block allocation table with the next entry in the buffer block allocation table if the location is the last location in the block and the location is marked as taken.

If it was determined that the location is marked as available, then a buffer allocation table location marker 1126 coupled to the buffer allocation table block location examiner 1116 may mark the location as taken. Then the buffer block allocation table entry can be marked as available and the buffer ID returned to the requester.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for managing a buffer request in a system management controller, the method comprising:
receiving the buffer request;
checking a buffer block allocation table for an entry indicating an available block;
marking said buffer block allocation table entry as taken;
checking a buffer allocation table block corresponding to said buffer block allocation table entry for an entry indicating an available block; and
marking said buffer allocation table block entry as taken.

2. The method of claim 1, wherein said checking a buffer block allocation table comprises:
examining a next entry in said buffer block allocation table to determine if it is marked as available; and
repeating said examining if it is not marked as available.

3. The method of claim 1, wherein said checking a buffer allocation table block comprises:
examining a first location in a buffer allocation table block corresponding to said buffer block allocation table entry to determine if it is marked as available;
determining if said location is a last location in said corresponding block in said buffer allocation table if said location is marked as taken;
repeating said examining a first location in a buffer allocation table block and said determining if said location is a last location with a next location in said corresponding block in said buffer allocation table if said location is not a last location in said corresponding block in said buffer allocation table and said location is marked as taken;
marking said buffer block allocation table entry as available if said location is a last location in said corresponding block in said buffer allocation table and said location is marked as taken; and
repeating said checking a buffer block allocation table, marking said buffer block allocation table entry, checking a buffer allocation table block, and marking said buffer allocation table block entry with a next entry in said buffer block allocation table if said location is a last location in said corresponding block in said buffer allocation table and said location is marked as taken.

4. The method of claim 1, further comprising:
determining if said entry is a last entry in said buffer block allocation table; and
returning an error if said entry is a last entry in said buffer block allocation table and it is marked as taken.

5. The method of claim 3, further comprising:
passing a buffer identification corresponding to the location to a requester if said location is marked as available.

6. An apparatus for managing a buffer request in a system management controller, the apparatus comprising:
a buffer request receiver;
a first memory;
a second memory;
a buffer block allocation table checker coupled to said buffer request receiver and to said first memory;
a buffer block allocation table marker coupled to said first memory and to said buffer block allocation table checker;
a buffer allocation table checker coupled to said second memory and to said buffer block allocation table checker; and
a buffer allocation table marker coupled to said second memory and to said buffer allocation table checker.

7. The apparatus of claim 6, wherein said buffer block allocation table checker comprises:
a buffer block allocation table next entry examiner; and
a iterator coupled to said buffer block allocation table next entry examiner.

8. The apparatus of claim 6, wherein said buffer allocation table checker comprises:
a buffer allocation table block location examiner;
a last location determiner coupled to said buffer allocation table block first location examiner;
a first iterator coupled to said buffer allocation table block first location examiner and to said last location determiner;
a buffer block allocation table entry marker coupled to said last location determiner;
a second iterator coupled to said buffer allocation table block location examiner, said last location determiner, said first iterator, and said buffer block allocation table entry marker.

9. An apparatus for managing a buffer request in a system management controller, the apparatus comprising:
means for receiving the buffer request;
means for checking a buffer block allocation table for an entry indicating an available block;
means for marking said buffer block allocation table entry as taken;
means for checking a buffer allocation table block corresponding to said buffer block allocation table entry for an entry indicating an available block; and
means for marking said buffer allocation table block entry as taken.

10. The apparatus of claim 9, wherein said means for checking a buffer block allocation table comprises:
means for examining a next entry in said buffer block allocation table to determine if it is marked as available; and
means for repeating said examining if it is not marked as available.

11. The apparatus of claim 9, wherein said means for checking a buffer allocation table block comprises:
means for examining a first location in a buffer allocation table block corresponding to said buffer block allocation table entry to determine if it is marked as available;
means for determining if said location is a last location in said corresponding block in said buffer allocation table if said location is marked as taken;
means for repeating said examining a first location in a buffer allocation table block and said determining if said location is a last location with a next location in said corresponding block in said buffer allocation table if said location is not a last location in said corresponding block in said buffer allocation table and said location is marked as taken;
means for marking said buffer block allocation table entry as available if said location is a last location in said corresponding block in said buffer allocation table and said location is marked as taken; and
means for repeating said checking a buffer block allocation table, marking said buffer block allocation table entry, checking a buffer allocation table block, and marking said buffer allocation table block entry with a next entry in said buffer block allocation table if said location is a last location in said corresponding block in said buffer allocation table and said location is marked as taken.

12. The apparatus of claim 9, further comprising:
means for determining if said entry is a last entry in said buffer block allocation table; and
means for returning an error if said entry is a last entry in said buffer block allocation table and it is marked as taken.

13. The apparatus of claim 11, further comprising:
passing a buffer identification corresponding to the location to a requester if said location is marked as available.

14. A program storage device readable by a machine, tangibly embodying a program of instructions executable by the machine to perform a method for managing a buffer request in a system management controller, the method comprising:
receiving the buffer request;
checking a buffer block allocation table for an entry indicating an available block;
marking said buffer block allocation table entry as taken;
checking a buffer allocation table block corresponding to said buffer block allocation table entry for an entry indicating an available block; and
marking said buffer allocation table block entry as taken.
